(19) United States
(12) Patent Application Publication
(10) Pub. No.: US 2008/0214202 A1
(43) Pub. Date: Sep. 4, 2008

(54) Method and Apparatus for Bluetooth Discoverability Using Region Estimation

(75) Inventor: Patrick A. Toomey, Chicago, IL (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/681,515

(22) Filed: Mar. 2, 2007

(51) Int. Cl. H04Q 7/20

(52) U.S. Cl. 455/456.1

(57) ABSTRACT

Embodiments of the invention generally provide a method and apparatus for Bluetooth discoverability using region estimation. One embodiment of a method for controlling Bluetooth discoverability of a wireless device includes monitoring the physical location of the wireless device and enabling Bluetooth discoverability if the current physical location of the wireless device is within a trusted region or disabling Bluetooth discoverability if the current physical location of the wireless device is outside of the trusted region.

### FIELD OF THE INVENTION

The present invention generally relates to wireless communications, and more particularly relates to the Bluetooth communications protocol.

### BACKGROUND OF THE INVENTION

Enabling or disabling Bluetooth discoverability presents a balance between security and convenience. For example, some manufacturers of Bluetooth-enabled devices enable discoverability by default, because it is convenient for users to use Bluetooth functionality in an unimpeded manner. On the other hand, some manufacturers disable discoverability by default, because there are security implications in allowing a device to constantly give away its availability information.

If a user wants to send data quickly to a coworker, and the receiver has disabled discoverability, this becomes inconvenient, as the receiver must figure out how to enable discoverability on his or her device before telling the sender that he or she is ready to receive the data. Meanwhile, the sender must be prepared to send while the receiver remains discoverable, or risk having to begin the process all over again. Thus, if discoverability is not enabled, it may prove very inconvenient to attempt to communicate with another device. On the other hand, if a device is always discoverable, then the device may be subject to attacks that rely solely on the ability to identify a device's presence. Neither of these policies is inherently better that the other, as both present users with drawbacks.

Therefore, there is a need in the art for a method and apparatus for Bluetooth discoverability using region estimation as a mechanism for balancing security concerns and convenience during device usage.

### BRIEF DESCRIPTION OF THE DRAWINGS

So that the manner in which the above recited embodiments of the invention are attained and can be understood in detail, a more particular description of the invention may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow diagram illustrating one embodiment of a method 100 for Bluetooth discoverability;

FIG. 2 is a flow diagram illustrating one embodiment of a method 200 for Bluetooth discoverability;

FIG. 3A is a block diagram illustrating a first embodiment of a dynamically defined trusted region for Bluetooth discoverability;

FIG. 3B is a block diagram illustrating a second embodiment of a dynamically defined trusted region for Bluetooth discoverability;

FIG. 3C is a block diagrams illustrating a third embodiment of a dynamically defined trusted region for Bluetooth discoverability, in which expansion of the trusted region is limited;

FIG. 3D is a block diagram illustrating a fourth embodiment of a dynamically defined trusted region for Bluetooth discoverability; and

FIG. 4 is a high level block diagram of the present Bluetooth discoverability tool that is implemented using a general purpose computing device 400.

To facilitate understanding, identical reference numerals have been used, where possible, to designate identical elements that are common to the figures.

### DETAILED DESCRIPTION

Embodiments of the invention generally provide a method and apparatus for Bluetooth discoverability using region estimation. Embodiments of the present invention use dynamic region estimation in order to estimate a “region of trust” that approximates a user's workspace. The user's device will then be discoverable as long as it is physically located within this region of trust. The region of trust may evolve dynamically. Thus, the present invention provides a balance between the “default on” and “default off” policies for Bluetooth discoverability.

As discussed above, the default Bluetooth discoverability policies provided by most wireless device manufacturers fail to take into account real-world use cases. It is typical that a user of a wireless device will move between physical regions or locations in which he or she is more trusting of the surrounding individuals than of individuals in other regions. For example, a user may be more trusting of the surrounding individuals in the workplace or the home than he or she is of the surrounding individuals in the airport. In the former setting, it is inconvenient to not be discoverable, whereas in the latter setting, it may be preferable to hide one's self.

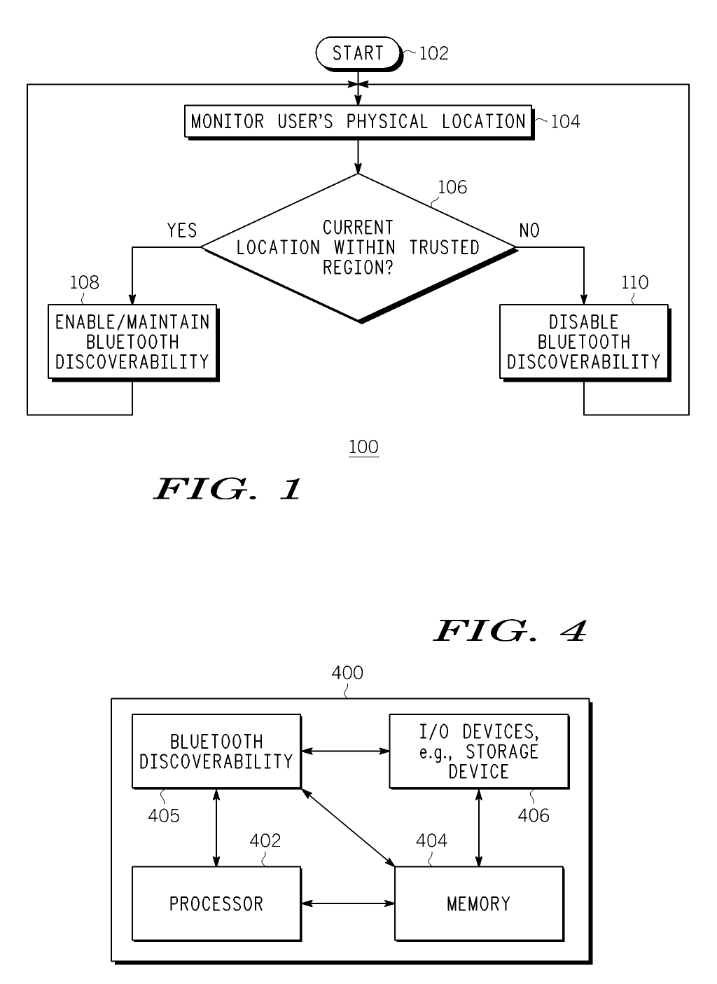

FIG. 1 is a flow diagram illustrating one embodiment of a method 100 for Bluetooth discoverability. The method 100 may be implemented, for example, at a wireless device (e.g., a cellular telephone, a personal digital assistant, a laptop computer or the like) that has Bluetooth capabilities.

The method 100 is initialized at step 102 and proceeds to step 104, where the wireless device monitors a user's physical location (i.e., the physical location of the wireless device). In one embodiment, the user's physical location is monitored using any one or more known methods for determining spatial locality. In one embodiment, the user's physical location is monitored using a Global Positioning System (GPS) integrated into the wireless device.

In step 106, the wireless device determines whether the user's current location is within a “trusted” region. As discussed above, the trusted region is a physical region defined by the user within which the user is likely to be surrounded by individuals that he or she trusts (e.g., home, the workplace or the like) and within which the user desires Bluetooth discoverability (e.g., as a default). In one embodiment, the trusted region is defined dynamically. One embodiment of a method for dynamically defining a region of trust is described in greater detail with respect to FIG. 2.

If the wireless device concludes in step 106 that the user's current location is within the trusted region, the wireless device proceeds to step 108 and enables (if not currently enabled) or maintains (if already enabled) Bluetooth discoverability. The wireless device then returns to step 104 and proceeds as described above to monitor the user's physical location.

Alternatively, if the wireless device concludes in step 106 that the user's current location is not within the trusted region, the wireless device proceeds to step 108 and disables Bluetooth discoverability. The wireless device then returns to step 104 and proceeds as described above to monitor the user's physical location.

The method 100 therefore creates a context (based on trusted regions and current physical locations) on which a policy decision regarding Bluetooth discoverability is made. Thus, a balance is struck between security and usability. When the user is within the defined region of trust, he or she is granted the convenience of using a discoverable Bluetooth device. However, when the user migrates outside of the region of trust, the user is protected from malicious individuals by disabling Bluetooth discoverability.

FIG. 2 is a flow diagram illustrating one embodiment of a method 200 for Bluetooth discoverability. Specifically, the method 200 provides detail beyond the high-level description provided with respect to FIG. 1. Like the method 100, the method 200 may be implemented, for example, at a wireless device (e.g., a cellular telephone, a personal digital assistant or the like) that has Bluetooth capabilities.

The method 200 is initialized at step 202 and proceeds to step 204, where the wireless device receives a request from a user of a wireless device to enable Bluetooth discoverability. In step 206, the wireless device enables the Bluetooth discoverability, in response to the request received in step 204.

In step 208, the wireless device receives an indication from the user that the user's current physical location is within a “trusted” region. As described above, the trusted region is a physical region defined by the user within which the user is likely to be surrounded by individuals that he or she trusts (e.g., home, the workplace or the like) and within which the user desires Bluetooth discoverability (e.g., as a default). For example, the user may be in his or her office.

In response to the indication received in step 208, the wireless device defines a default trusted region in step 209. The default trusted region includes the user's current physical location, plus some amount of surrounding area that defines a bounded amount of allowed movement within which Bluetooth discoverability will be enabled/maintained as a default. The size of the default trusted region does not necessarily correspond to the user's entire building space (e.g., the entire house, the entire office or the like), since the wireless device is not likely to have a priori knowledge of the geometry of the user's current space. Thus, the default trusted region represents only a first-level approximation of the region in which the user will use the wireless device. In one embodiment, the size of the default trusted region depends, at least in part, on the spatial resolution of the wireless device. For example, the size of the default trusted region might be two to two and one half meters in all directions, plus or minus the spatial resolution of the wireless device.

Once a default trusted region is defined, the wireless device proceeds to step 210 and monitors the user's (i.e., the wireless device's) physical location. In one embodiment, the user's physical location is monitored using any one or more known methods for determining spatial locality. In one embodiment, the user's physical location is monitored using a Global Positioning System (GPS). In one embodiment, step 210 repeats in accordance with a certain parameter or set of parameters that establish when to check to see if the user is within the trusted region. This parameter may either be set to a default value or may be user-defined. Examples of parameters include time (e.g., check user position now relative to x seconds ago) or distance (the user has moved y feet from the last measured position).

In step 212, the wireless device determines whether the user's current physical location is within the default trusted region. If the wireless device concludes in step 212 that the user's current position is within the default trusted region, the wireless device proceeds to step 214 and maintains Bluetooth discoverability. The wireless device then returns to step 210 and proceeds as described above to monitor the user's physical location.

Alternatively, if the wireless device concludes in step 212 that the user's current physical location is not within the default trusted region, the wireless device proceeds to step 213 and disables Bluetooth discoverability. Thus, at this point, the user is physically located in a “gray region” within which it remains to be determined (as described in further detail below) whether Bluetooth discoverability should be enabled or maintained without user input (i.e., whether the trusted region should be expanded to include the gray region).

In step 216 the wireless device determines whether the user's current physical location is close enough to the default trusted region (i.e., within some configurable allowable bounded distance, such as ten meters, from the default trusted region). Step 216 substantially ensures that extremely disparate locations do not converge into one large trusted region. For example, consider a default trusted region defined by an original user location within the user's office, which is located at one end of a long hallway. If the user exits his or her office and walks down to a second office located at the other end of the hallway (i.e., beyond the allowable bounded distance from the default trusted region), the method 200 prevents the default trusted region from expanding all the way to the second office.

In one embodiment, the allowable bounded distance is a function of environment. That is, the current user environment will define how close is “close enough” to the default trusted region, for the purposes of step 216. For instance, when the user indicates that a current location is trusted (i.e., as in step 208), the wireless device may also prompt the user for a definition of the type of environment within which the current location is (e.g., home, work, etc.). The allowable bounded distance may vary based on the type of environment. For example, the allowable bounded distance at home may be smaller than the allowable bounded distance at work, because the user may have more need to be easily discoverable by in-range Bluetooth devices at work than he or she does at home.

If the wireless device concludes in step 216 that the user's current physical location is close enough to the default trusted region, the wireless device proceeds to step 217 and determines whether the user has remained relatively immobile in that location (i.e., has not migrated within some bounded range of movement) for a threshold period of time. In one embodiment, the bounded range of movement is a configurable parameter with a default value. For instance, the bounded range of movement may dictate, as a default, that a user has remained relatively immobile if the user has not strayed more than one meter in any direction from a given point. Thus, steps 212-217 collectively confirm that the user's current physical location is a “new” (i.e., eligible to be considered for inclusion in an expanded trusted region) location. For example, if the user attends a meeting in a conference room outside of the default trusted region (but within the allowable bounded distance from the default trusted region), the user may wander about the confined space of the conference room, but stay within the allowable bounded distance, and this localized movement will be defined as “immobility” if the movement is less than that specified by the bounded range. If this localized movement takes place over the threshold period of time, then the conference room may be considered a “new” location eligible for inclusion in an expanded trusted region. This ensures that transient locations through which the user quickly passes (e.g., while migrating from point A to point B) do not unnecessarily expand the trusted region.

If the wireless device concludes in step 217 that the user has not remained immobile for a minimal period of time, then the wireless device returns to step 214 and re-enables Bluetooth discoverability. However, at this point, the current trusted region is not yet expanded to include the user's current location, so Bluetooth discoverability is not enabled in the user's current location as a default.

Alternatively, if the wireless device concludes in step 217 that the user has remained immobile for the minimal period of time, the wireless device proceeds to step 218 and expands the default trusted region to include the user's current location. In one embodiment, the size of the trusted region is expanded to include the furthest measured point to which the user has traveled, relative to the default trusted region. For instance, if the default trusted region was defined by the user's original location, which was his or her office, subsequent user locations might include a conference room in the user's office building and a coworker's office in the office building. The trusted region can be expanded to include one or more of these subsequent locations. Thus, over time, the method 200 dynamically approximates the trusted region in which Bluetooth discoverability is enabled by making location measurements as the user migrates. The wireless device then returns to step 214 and maintains Bluetooth discoverability in the expanded trusted region.

Referring back to step 216, if the wireless device concludes that the user's current physical location is not close enough to the default trusted region, the wireless device returns to step 210 and proceeds as described above to monitor the user's physical location.

Although the method 200 is described within the exemplary context of enabling Bluetooth discoverability in trusted regions of a user's workplace, it will be appreciated that the same model can be used similarly in a variety of contexts, including the home and various social settings. Moreover, certain embodiments of the present invention will allow the user to disable dynamic growth of the trusted region, such that the trusted region will not expand beyond the initial default definition. It will be further appreciated that the method 200 may be occasionally re-initiated to create one or more new trusted regions not connected to an existing trusted region.

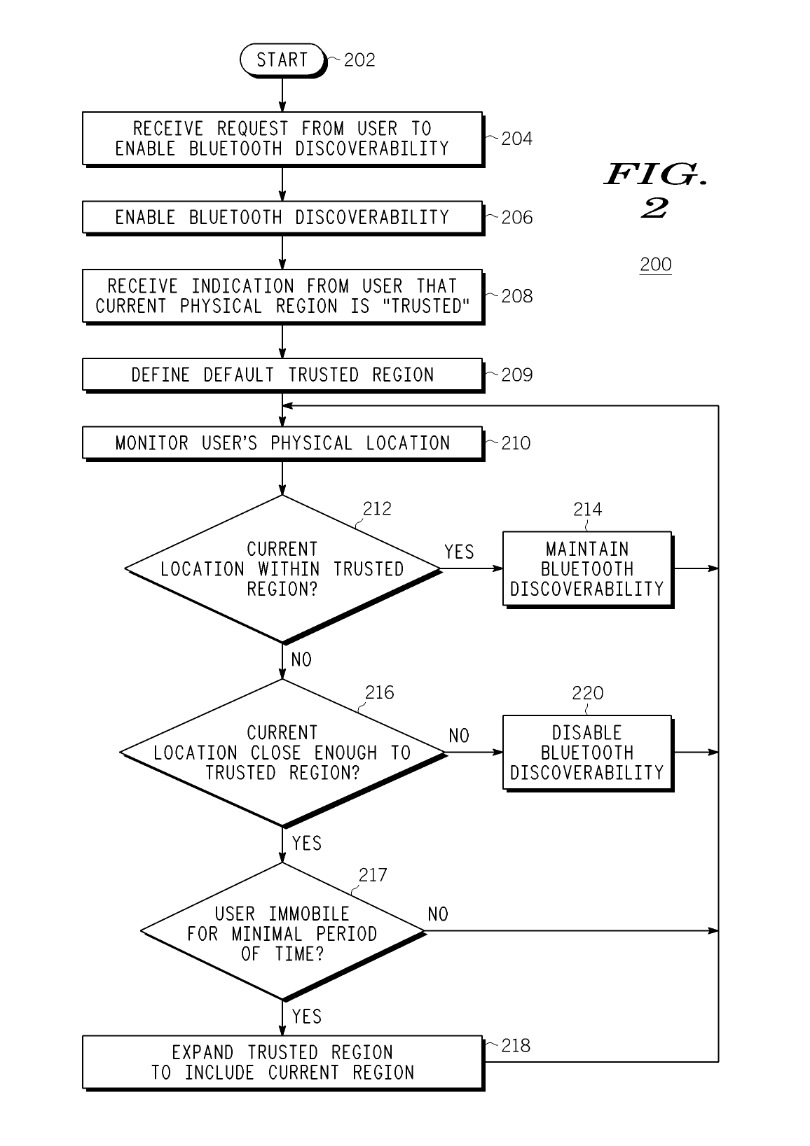

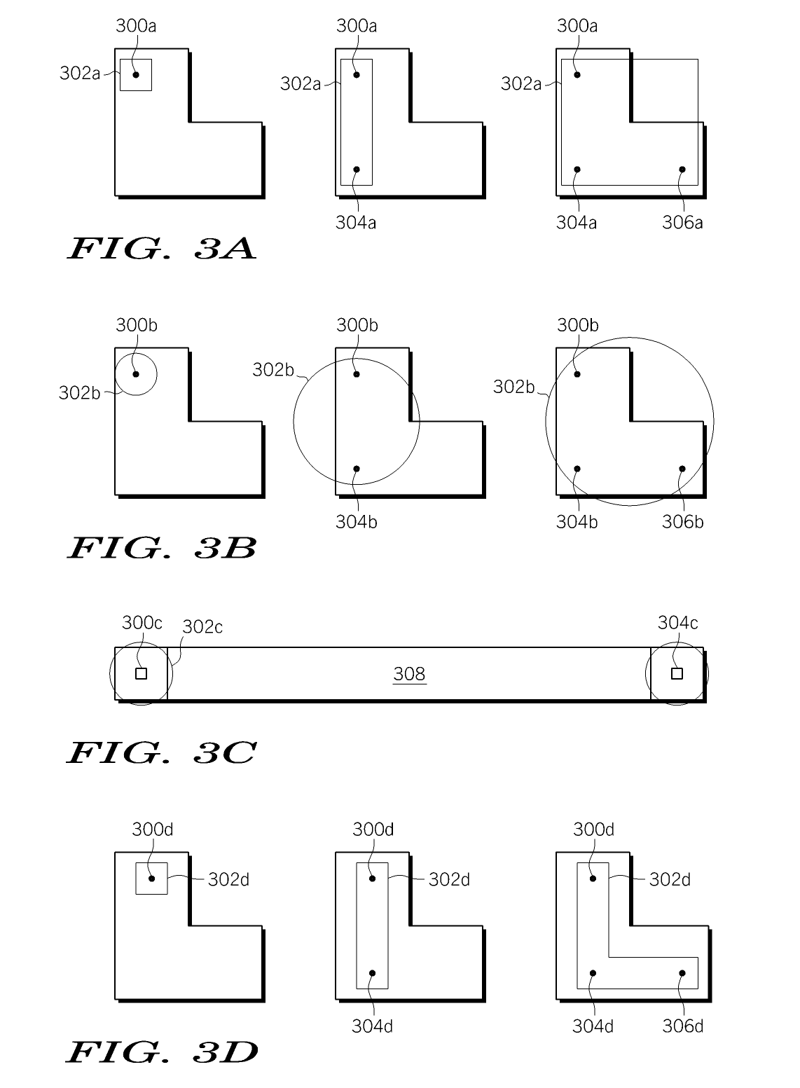

As discussed above with respect to FIG. 2, a trusted region for Bluetooth discoverability can be dynamically expanded in accordance with user movement. FIGS. 3A, 3B and 3D, for example, are block diagrams illustrating first and second and third embodiments of dynamically defined trusted regions for Bluetooth discoverability. Specifically, FIG. 3A illustrates a trusted region that is defined in terms of a rectangular or square spatial region (e.g., where parameters defining the trusted region include at least a latitude and a longitude), whereas FIG. 3B illustrates a trusted region that is defined in terms of an elliptical or circular spatial region (e.g., where parameters defining the trusted region include at least a center point and a radius) and FIG. 3D illustrates a trusted region that is linearly expanded (where expansion closely follows user movement). Various other mechanisms for defining the trusted region, including more elaborate and/or more accurate mechanisms, may also be used. Default trusted regions 302a, 302b and 302d define spatial areas surrounding original user locations 300a, 300b and 300d, respectively (i.e., locations at which the user sends an indication that the current location is trusted).

As illustrated, the default trusted regions 302a, 302b and 302d are expanded to encompass subsequent user locations 304a and 306a, 304b and 306b, and 304d and 306d respectively. For instance, if the user's original location 300a, 300b or 300d was his or her office, subsequent locations 304a and 306a, 304b and 306b, or 304d and 306d might be a conference room in the user's office building and a coworker's office in the office building. Thus, over time, the trusted region in which Bluetooth discoverability is enabled is dynamically approximated by making location measurements as the user migrates.

FIG. 3C, on the other hand, is a block diagram illustrating a fourth embodiment of a dynamically defined trusted region for Bluetooth discoverability, in which expansion of the trusted region is limited. As discussed above, although the present invention dynamically expands the trusted region in accordance with user movement, it is also desirable to ensure that extremely disparate locations do not converge into one large trusted region. For example, consider a default trusted region 302c defined by an original user location 300c within the user's office, which is located at one end of a long hallway 308. If the user exits his or her office and walks down to a second office (i.e., second user location 304c) located at the other end of the hallway 308 (i.e., beyond the allowable bounded distance from the default trusted region 302c), the method 200 prevents the default trusted region 302c from expanding all the way to the second office.

FIG. 4 is a high level block diagram of the present Bluetooth discoverability tool that is implemented using a general purpose computing device 400. In one embodiment, a general purpose computing device 400 comprises a processor 402, a memory 404, a Bluetooth discoverability module 405 and various input/output (I/O) devices 406 such as a display, a keyboard, a mouse, a modem, a network connection and the like. In one embodiment, at least one I/O device is a storage device (e.g., a disk drive, an optical disk drive, a floppy disk drive). It should be understood that the Bluetooth discoverability module 405 can be implemented as a physical device or subsystem that is coupled to a processor through a communication channel.

Alternatively, the Bluetooth discoverability module 405 can be represented by one or more software applications (or even a combination of software and hardware, e.g., using Application-Specific Integrated Circuits (ASIC)), where the software is loaded from a storage medium (e.g., I/O devices 406) and operated by the processor 402 in the memory 404 of the general purpose computing device 400. Additionally, the software may run in a distributed or partitioned fashion on two or more computing devices similar to the general purpose computing device 400. Thus, in one embodiment, the Bluetooth discoverability module 405 for enabling Bluetooth discoverability based on region estimation described herein with reference to the preceding figures can be stored on a computer readable medium or carrier (e.g., RAM, magnetic or optical drive or diskette, and the like).

Thus, the present invention represents a significant advancement in the field of wireless communications. Embodiments of the present invention use dynamic region estimation in order to estimate a “region of trust” that approximates a user's workspace. The user's device will then be discoverable as long as it is physically located within this region of trust. Thus, the present invention provides a balance between the “default on” and “default off” policies for Bluetooth discoverability.

While the foregoing is directed to embodiments of the invention, other and further embodiments of the invention may be devised without departing from the basic scope thereof.

What is claimed is:

1. A method for controlling Bluetooth discoverability of a wireless device, the method comprising:
monitoring a physical location of the wireless device;
enabling the Bluetooth discoverability if a current physical location of the wireless device is within a trusted region; and
disabling the Bluetooth discoverability if the current physical location of the wireless device is outside of the trusted region.

2. The method of claim 1, wherein the trusted region is a physical region in which a user of the wireless device desires Bluetooth discoverability.

3. The method of claim 2, wherein the trusted region is defined by:
defining a default trusted region in accordance with a first physical location of the wireless device, in response to an indication from the user that the first physical location is trusted.

4. The method of claim 3, wherein the default trusted region includes the first physical location of the wireless device, plus a spatial area surrounding the first physical location.

5. The method of claim 3, further comprising:
dynamically expanding the default trusted region in accordance with movement of the wireless device, in order to define an expanded trusted region.

6. The method of claim 5, wherein the expanding comprises:
determining that a second physical location of the wireless device is within a threshold distance from the default trusted region; and
expanding the trusted region to include the second physical location of the wireless device.

7. The method of claim 6, wherein the threshold distance is defined in accordance with a type of environment in which the wireless device is operating.

8. The method of claim 6, further comprising:
determining that the wireless device has remained within a bounded range of movement relative to the second physical location for at least a threshold period of time before expanding the trusted region.

9. A computer readable medium containing an executable program for controlling Bluetooth discoverability of a wireless device, where the program performs the steps of:
monitoring a physical location of the wireless device;
enabling the Bluetooth discoverability if a current physical location of the wireless device is within a trusted region; and
disabling the Bluetooth discoverability if the current physical location of the wireless device is outside of the trusted region.

10. The computer readable medium of claim 9, wherein the trusted region is a physical region in which a user of the wireless device desires Bluetooth discoverability.

11. The computer readable medium of claim 10, wherein the trusted region is defined by:
defining a default trusted region in accordance with a first physical location of the wireless device, in response to an indication from the user that the first physical location is trusted.

12. The computer readable medium of claim 11, wherein the default trusted region includes the first physical location of the wireless device, plus a spatial area surrounding the first physical location.

13. The computer readable medium of claim 11, further comprising:
dynamically expanding the default trusted region in accordance with movement of the wireless device, in order to define an expanded trusted region.

14. The computer readable medium of claim 13, wherein the expanding comprises:
determining that a second physical location of the wireless device is within a threshold distance from the default trusted region; and
expanding the trusted region to include the second physical location of the wireless device.

15. The computer readable medium of claim 14, wherein the threshold distance is defined in accordance with a type of environment in which the wireless device is operating.

16. The computer readable medium of claim 14, further comprising:
determining that the wireless device has remained within a bounded range of movement relative to the second physical location for at least a threshold period of time before expanding the trusted region.
